(19) United States
(12) Patent Application Publication
(10) Pub. No.: US 2007/0064199 A1
(43) Pub. Date: Mar. 22, 2007

(54) Projection display device

(76) Inventors: Jon L. Schindler, Glenview, IL (US); George T. Valliath, Winnetka, IL (US); Huinan J. Yu, Buffalo Grove, IL (US)

Correspondence Address: MOTOROLA, INC., 1303 EAST ALGONQUIN ROAD, IL01/3RD, SCHAUMBURG, IL, 60196, US

(21) Appl. No.: 11/229,932

(22) Filed: Sep. 19, 2005

(51) Int. Cl. G03B 21/26

(52) U.S. Cl. 353/30

(57) ABSTRACT

A projection display device (104) to provide a high resolution projected image is disclosed. The projection display device includes a communication unit (202) to communicate with a host device (102) for receiving one or more encoded inputs, a system processor (204) to decode the one or more encoded inputs, and generate a high resolution display, and a display unit (206) to project the high resolution display. The communication unit is further capable of enabling the host device to control the projection display device.

### FIELD OF THE INVENTION

This invention relates in general to the field of projection display devices, and more specifically to projection display devices for viewing high resolution images in mobile applications.

### BACKGROUND OF THE INVENTION

In recent years, electronic devices such as mobile phones, Personal Digital Assistants (PDAs), messaging devices, and the like, are increasingly being used for data creation and data transfer. Examples of data include images, videos, and document files. Existing electronic devices commonly use Liquid Crystal Display (LCD) screens to view received data and stored data. However, direct view LCD screens offer only a limited display resolution and physical size due to the limited size of the device. Therefore, high resolution images may not be viewed properly on these electronic devices. It is also difficult to share the content displayed on the built-in LCD screen with other people without passing the devices themselves around.

Several display technologies could potentially be used to solve the electronic device size limitations. One such display technology includes use of virtual image displays. Virtual image displays that employ micro display imagers and optical lens systems require near eye usages, which has generally been deemed awkward ergonomically to implement. Extendable or rollable displays that are made of flexible plastic materials have not yet proven desired mechanical properties for reliable use under the promised bending conditions.

In addition, these electronic devices may have one or more of the following additional limitations for viewing high resolution images. First, the existing electronic devices may not have the required processing capabilities to generate high resolution images. Second, the existing electronic devices may not support an integrated high resolution display due to constraints on cost, size, and power consumption. Third, even if attached to an external, high resolution display over an interface, these electronic devices may not support the high data rate interface required for the transfer of high resolution displays.

### BRIEF DESCRIPTION OF THE FIGURES

The present invention is illustrated by way of example, and not limitation, in the accompanying figures, in which like references indicate similar elements, and in which:

FIG. 1 is a block diagram illustrating an exemplary environment, where various embodiments of the present invention can be practiced;

FIG. 2 is a block diagram illustrating components of an exemplary projection display device, in accordance with an embodiment of the present invention; and

FIG. 3 is a block diagram illustrating an exemplary projection display device, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE EMBODIMENTS

Various embodiments of the present invention provide a projection display device. The projection display device includes a communication unit for communicating with a host device such as a mobile phone, a laptop, a Personal Digital Assistant (PDA), and the like. The communication unit is capable of enabling the host device to control the operation of the projection display device. The projection display device also includes a system processor and a display unit. The system processor decodes encoded inputs received by the communication unit and generates a high resolution image. Further, the display unit projects the high resolution image to form a display.

Before describing in detail the projection display device in accordance with the present invention, it should be observed that the present invention resides primarily in combinations of method steps and apparatus components related to the projection display device. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “another”, as used herein, is defined as at least a second or more. The terms “including” and/or “having”, as used herein, are defined as comprising.

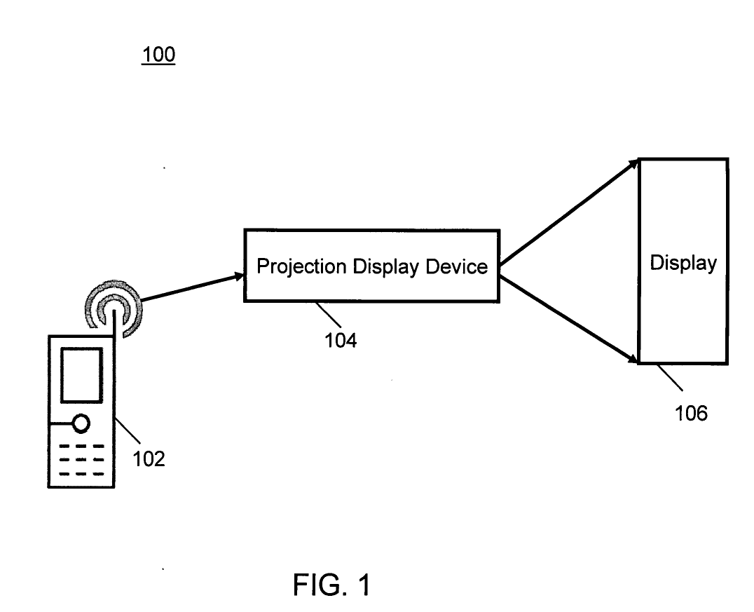

FIG. 1 is a block diagram illustrating an exemplary environment 100, where various embodiments of the present invention can be practiced. The exemplary environment 100 includes a host device 102 and a projection display device 104. Examples of the host device 102 include a mobile phone, a laptop, a Personal Digital Assistant (PDA), a digital camera, and the like. The projection display device 104 is capable of communicating with the host device 102 through wireless or wired means. The projection display device 104 receives one or more encoded inputs, such as compressed image files, compressed video files, and compressed document files, from the host device 102. Encoding of inputs results in shorter time for data transfer due to reduction in the size of the inputs. The one or more encoded inputs are decoded by the projection display device 104 to generate a display 106. In accordance with various embodiments of the present invention, the projection display device 104 may be a laser scanning based projection device, a transmissive micro imager based projection device, an emissive micro imager based projection device, a reflective micro imager based projection device, a holographic technology based projection device, a Cathode Ray Tube (CRT) based projection device, a Field Emission Display (FED), or a Digital Light Processing (DLP) based projection device. In an embodiment of the present invention, display 106 is generated on a screen by the projection display device 104.

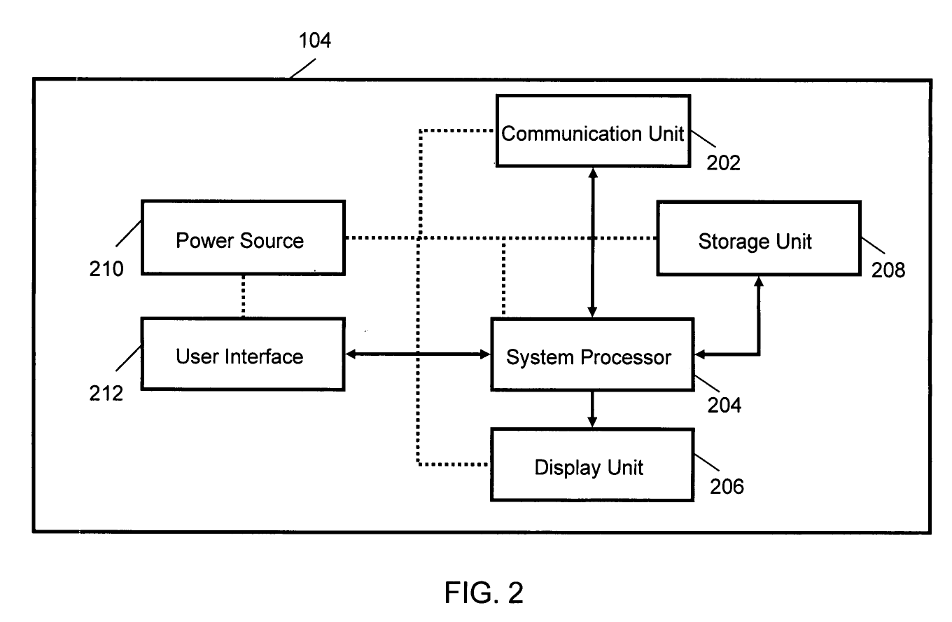

FIG. 2 is a block diagram illustrating components of the projection display device 104, in accordance with an embodiment of the present invention. The projection display device 104 includes a communication unit 202, a system processor 204, and a display unit 206. The communication unit 202 communicates with the host device 102 (shown in FIG. 1) to receive or transmit one or more encoded inputs, such as, compressed image files, compressed video files, and compressed document files. In accordance with an embodiment of the present invention, the communication unit 202 may be a wired communication interface, such as a Universal Serial Bus (USB) port. In accordance with another embodiment of the present invention, the communication unit 202 may be a wireless communication unit such as a Bluetooth unit, a wireless local area network (WLAN) communication unit, an ultra wide band (UWB) unit, a radio frequency communication unit, a digital video broadcast unit (DVB-H), or an infrared communication unit. The communication unit 202 is capable of receiving encoded inputs from the host device 102. For example, the communication unit 202 may receive compressed image files from the host device 102, such as a digital camera. Examples of the image files include Joint Photographic Experts Group (JPEG) image files, Portable Network Graphics (PNG) image files, RAW image files, Graphic Interchange Format (GIF) image files, or files with other encoded formats. Similarly, the communication unit 202 may receive encoded video files from the host device 102. For example, the communication unit 202 may receive video files encoded in different formats, such as Moving Pictures Experts Group-4 (MPEG-4), H.263, MPEG-2, Audio Video Interleaved (AVI), Windows Media Video (WMV), and QuickTime. The communication unit 202 may also include a TV tuner such as a Digital Video Broadcast for Handheld (DVB-H) tuner. In various embodiment of the present invention, the communication unit 202 is capable of enabling the host device 102 to control the projection display device 104. The users may control the functions of the projection display device 104 using a host device User Interface (UI). These functions include, but are not limited to, power On/Off, menu navigation, navigation within particular application software, file manipulation, and audio volume control. The host device 102 and the projection display device 104 may interact to exchange control information and device configuration settings over a data interface.

The system processor 204 decodes the received inputs. The system processor 204 may perform the decoding operation by executing software instructions, through dedicated decoding hardware, and through a combination of various methods. The decoding steps in the system processor 204 follow the already existing methods for decoding the inputs, such as still image files, video files, or document files. For example, the decoding process for JPEG still images follows the steps of entropy decoding (e.g. Huffman), dequantization, inverse zig-zag sequencing, and Inverse Discrete Cosine Transform to recreate the pixel information of the original bitmap image. Similarly for MPEG-4 video files, in addition to steps similar to the JPEG decoding process, the decoding process follows further steps of motion compensation to recover data from the temporal variations between frames in the original video sequence. After decoding the encoded inputs, the system processor 204 generates a high resolution image of the received inputs. The system processor 204 sends the decoded inputs to the display unit 206, which is operatively coupled to the system processor 204. The display unit 206 projects the high resolution image on to a screen to form the display 106 (shown in FIG. 1).

In various embodiments of the invention, the system processor 204 is further capable of formatting the decoded inputs, based on the properties of the input. For example, in the present invention, for a visual media content of a three mega-pixel JPEG image (2000×1500 pixels), which exceeds the resolution of the display 106 when decoded, the projection display device 104 formats this image by resizing it to the maximum screen resolution of the display 106. Similarly, for a visual media content of a Quarter Common Intermediate Format (QCIF) resolution (176×144 pixels) video clip in MPEG-4 encoding, as generated by many existing host devices, the projection display device 104 decodes this video clip file and scales the video image to a larger size, such as Common Intermediate Format (CIF) (352×288 pixels) or Video Graphics Array (VGA) (640×480 pixels) resolution to fill more of the display 106. In an embodiment of the present invention, the high resolution display has a resolution of Extended Graphics Array (XGA) (1024×768 pixels).

In an embodiment of the present invention, the projection display device 104 further includes a storage unit 208, a power source 210, and a UI 212. The storage unit 208 stores the inputs received from the host device 102, and supplies the stored inputs to the system processor 204 for decoding and further processing. The storage unit 208 enables stand-alone operation of the projection display device 104, as inputs can be stored and decoded at a later time for projection, without requiring any communication with the host device 102. In an embodiment of the present invention, the storage unit 208 may store software that may be required for operating the projection display device 104. In one embodiment of the present invention, the storage unit 208 includes at least one of a removable storage unit and a local storage unit. The removable storage unit can be a storage card of the host device 102, such as a Secure Digital (SD) card, a Multimedia Card (MMC), or the like. This enables stand-alone operation of the projection display device 104. Examples of the storage unit 208 include a Dynamic Random Access Memory (DRAM) and a Flash memory.

The power source 210 is operatively coupled to the other components of the projection display device 104, such as the communication unit 202, the system processor 204, the display unit 206, and the storage unit 208, to provide power for their operations. In an embodiment of the present invention, the power source 210 is an in-built power source, such as a rechargeable battery. The in-built power source enables handheld operation of the projection display device 104. In addition, the in-built power source provides portability to the projection display device 104. In another embodiment of the present invention, the power source 210 is an Alternating Current (AC) adapter. The UI 212 provides an interface for a user to give commands to the projection display device 104. The UI 212 may include menus and operation commands presented in a graphical form or a textual form on a display for the user to choose from. The UI 212 may further include one or more buttons to enable the user to operate the projection display device 104. The UI 212 may include a set of keys for handling tasks such as power On/Off, navigation among menu items, audio volume control, or it could include a touch pad for navigation with a cursor, or it could even include a QWERTY keypad for text entry. The display 106 from the projection display device 104 may be used to present the menus that support the UI 212 functions, in accordance with various embodiment of the present invention.

Alternatively, an LCD could display the selected operation commands on its screen for visual confirmation from the user and display information for system dialogue when the display 106 is not properly functioning. The UI 212 could also include indicators such as icons lit by LEDs or electroluminescent light sources to communicate power status, battery charging status, data communication status, and the like. In an embodiment of the present invention, the UI 212 may be used to operate the host device 102. For example, if the host device 102 is a mobile phone, the user may see the UI of the mobile phone at a much higher resolution. Similarly, the projection display device 104 may show a high resolution view of a calendar or a phone book data that resides in the host device 102. The host device 102 would transfer this data to the projection display device 104 and the projection display device 104 would process the data to generate a high resolution display. In more advanced applications, the projection display device 104 could be used as an extension to a UI of the host device 102. The UI of the host device 102 has also been referred to as a host device UI. Users could create message texts or documents using a QWERTY keyboard attached to the projection display device 104 and view the entered texts on the display 106 produced by the projection display device 104. The texts can then be communicated to the host device 102 either in a streaming fashion or in a data block. The texts may be processed by an application software such as an email, document processors, and the like, on the host device 102. Users could also view a high resolution version of application software of the host device 102 such as a document processing software, a web navigation software, a multimedia handling software, and a gaming software on the display 106 created by the projection display device 104. The elements of UI 212, such as, the key presses, the QWERTY keyboard, a touch pad, etc., may be used by the users to interface with the above mentioned application software to fulfill functions such as menu selections, text entrances, graphics navigation. The commands entered by the users, after viewing the high resolution images of the application, can be communicated to and processed by the application software running on the host device 102. The high resolution image of a new document, a new web page, a new video/picture or a new game frame can be rendered by the system processor 204 and displayed by the projection display device 104. In an embodiment of the present invention, the elements of UI 212 may be used to control the host device 102 by enabling the UI 212 to perform some functions of the host device UI. For example, when the host device 102 is a mobile phone, the projection display device 104 could use UI 212 to browse the phone book, to initiate a phone call, to answer a phone call, to mute or the change the volume/ring tone of the mobile phone. In another embodiment of the present invention, the projection display device 104 may be used together with the host device UI to perform more advanced communication tasks. For example, when the host device 102 is a camera phone, the projection device 104 can enable a video conferencing session by displaying the incoming video images on the projected display 106 at higher resolution and larger physical size than the built-in display on the host device 102, while the camera on the host device 102 could be more optimally oriented to capture the video images of sending end participants.

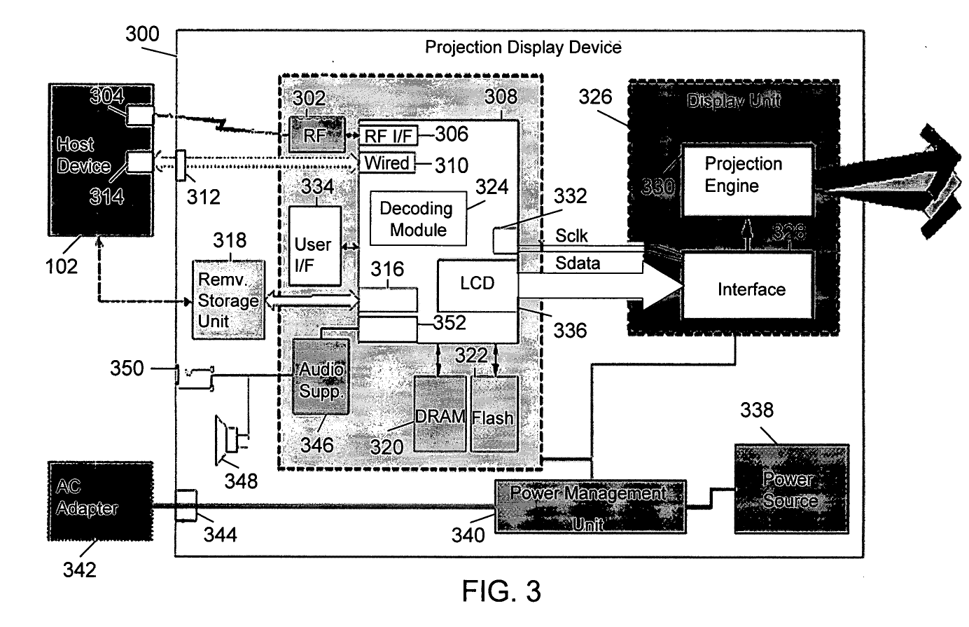

FIG. 3 is a block diagram illustrating a projection display device 300, in accordance with another embodiment of the present invention. The projection display device 300 communicates with the host device 102 through a wireless or wired communication unit. For example, a Radio Frequency (RF) unit 302 in the projection display device 300 may wirelessly communicate with an RF unit 304 in the host device 102 for transfer of one or more encoded inputs. In various embodiments of the present invention, the RF units 302 and 304 may be a Bluetooth unit, a WLAN communication unit, a UWB unit, a radio frequency communication unit, a DVB-H unit, or an infrared communication unit. The RF unit 302 may then communicate with or an RF Interface (I/F) 306 for transferring the encoded inputs to a system processor 308. Similarly, the projection display device 300 may communicate with the host device 102 through a wired interface 310. For example, a USB port 312 in the projection display device 300 may be used to communicate with a USB port 314 present in the host device 102. Other examples of the wired interface 310 include IEEE 1394, and existing data interfaces of separated video (s-video), video graphics array (VGA), and NTSC. The communication unit is capable of enabling the control of the projection display device 300 from the host device 102. The users may control the functions of the projection display device 300 using the host device UI. These functions include, but are not limited to, power On/Off, menu navigation, navigation within particular application software, file manipulation, and audio volume control. In an embodiment of the present invention, the encoded inputs may be sent directly to the system processor 308 for decoding. In another embodiment of the present invention, the encoded inputs may be stored in a storage unit 316 for decoding and projecting at a later time. In yet another embodiment of the present invention, a removable storage unit 318 is present in the projection display device 300. The removable storage unit 318 can be a storage card being used in the host device 102, such as a SD card, a MMC, or the like. In various embodiments of the present invention, the projection display device 300 also includes a DRAM 320 and a flash memory 322. The DRAM 320 and the flash memory 322 serve as storage units for software used to operate the projection display device 300. The DRAM 320 enables quick access to the software. The flash memory 322 provides non-volatile storage for software and user data.

A decoding module 324, present in the system processor 308, decodes the received inputs for generating a high resolution display. The system processor 308 may perform the decoding operation by executing software instructions, through dedicated decoding hardware, or through a combination of various existing methods. The decoding steps followed by the system processor 308 are same as the steps described for the system processor 204 (described in conjunction with FIG. 2). Decoded inputs are sent to a display unit 326, which is operatively coupled to the system processor 308, through an interface 328. A projection engine 330 present in the display unit 326 projects the high resolution display. The system processor 308 includes a configuration interface 332 for controlling the behavior of the display unit 326. In an embodiment of the present invention, this configuration interface 332 could employ the Inter-Integrated Circuit (12C) protocol. This interface employs two signals, clock (SCLK) and data (SDATA) to communicate between IC devices. The system processor 308 communicates commands and control data to the display unit 326 to make changes to configuration of the display unit 326 or to get the information about the status of the display unit 326. The system processor 308 may send configuration commands over the configuration interface 332 to the display unit 326 to change the light output of the display in order to achieve a different perceived brightness for the user. Further, the system processor 308 may send configuration commands to change the resolution of the displayed image, or to adjust the display for geometric distortions in the projected image. The system processor 308 may issue commands to obtain status information over the configuration interface 332 about, for example, the current light output, the brightness setting, the current display resolution, or the cumulative hours of operation of the display unit.

The projection display device 300 further includes a UI 334 for enabling a user to interact with the projection display device 300. For example, the UI 334 may provide menus and operation commands to the user to operate the projection display device 300. The UI 334 could include key presses for handling tasks such as power On/Off, navigation among menu items, audio volume control, in accordance with an embodiment of the present invention. The UI 334 includes a touch pad for navigation with a cursor, in accordance with another embodiment of the present invention. The UI 334 may include a QWERTY keypad for text entrance, in accordance with yet another embodiment of the present invention. The display 106 from the projection display device 300 can be used to present the menus in UI functions. Alternatively, an LCD 336 could display the selected operation commands on its screen for visual confirmation from the user and display information for system dialogue when the display 106 is not proper. The UI 334 could also include indicators such as icons lit by LEDs or electroluminescent light sources to communicate power status, charging status, data communication status, and the like. In various embodiments of the present invention, the projection display device 300 further includes a power source 338, coupled to a power management unit 340. In an embodiment of the present invention, the power source 338 is connected to an Alternating Current (AC) adapter 342 through a three-pin connector 344. The power source 338 provides power to various units of the projection display device 300 for their operations. The projection display device 300 may also include an audio support unit 346, coupled to a speaker 348, an audio jack 350, and having an audio interface 352, to provide sound while playing video files. The audio interface 352 provides the ability to decode encoded audio content, which may be a part of an encoded video file. For example, audio interface 352 may decode encoded audio content into a form that the audio support unit 346 would process into analog audio signals. These analog audio signals may be used to drive the speaker 348 or the audio output jack 350. The audio support unit 346 may provide the ability to amplify the analog audio signals to produce a louder output sound from the speaker 348 or the audio jack 350.

Various embodiments of the present invention, as described above, provide a projection display device for projecting a high resolution image. The projection display device is capable of decoding the received encoded inputs, which results in eliminating the need for any third party device, such as a computer, to perform the decoding. In addition, the projection display device supports transfer of data at a high rate due to transfer of encoded data.

Advantageously, the projection display device enables a high resolution image through image projection such that the size of the image can be adjusted to a much larger size than provided by the host device. Further, the image size can be determined to be within a wide range. In addition, the projection display device is capable of generating and displaying high resolution images regardless of factors such as the processing capability of the host device, the resolution of the original files, or the speed of the data interface. The projection display device is further capable of operating the host device, and may be operable from the host device as well. The projection display device provides similar levels of mobility as a large suite of host devices.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A projection display device for providing a high resolution projected image, the projection display device comprising:
a communication unit for communicating with a host device, wherein the communication unit is capable of receiving one or more encoded inputs from the host device, the communication unit is further capable of enabling the host device to control the projection display device;
a system processor capable of decoding the one or more encoded inputs for generating a high resolution display; and
a display unit operatively coupled to the system processor for projecting the high resolution image.

2. The projection display device according to claim 1, wherein the system processor is further capable of formatting the one or more inputs based on properties of the one or more inputs.

3. The projection display device according to claim 1, further comprising a power source, wherein the power source comprises at least one of an in-built power source, and an Alternating Current (AC) outlet.

4. The projection display device according to claim 3, wherein the in-built power source is a rechargeable battery.

5. The projection display device according to claim 1, further comprising:
a storage unit for storing the one or more inputs; and
a User Interface (UI) for enabling a user to operate the projection display device.

6. The projection display device according to claim 5, wherein the storage unit comprises at least one of a removable storage unit and a local storage unit.

7. The projection display device according to claim 5, wherein the UI enables the user to operate the host device.

8. The projection display device according to claim 1, wherein the projection display device is selected from the group consisting of a laser scanning based projection device, a transmissive micro imager based projection device, an emissive micro imager based projection device, a reflective micro imager based projection device, a holographic technology based projection device, a Cathode Ray Tube (CRT) based projection device, a Field Emission Display (FED) based projection device, and a Digital Light Processing (DLP) based projection device.

9. The projection display device according to claim 1, wherein the communication unit is a wireless communication unit.

10. The projection display device according to claim 9, wherein the wireless communication unit comprises at least one of a Bluetooth unit, a wireless local area network communication unit, a radio frequency communication unit, a digital video broadcast (DVB-H) communication unit, an ultra wideband (UWB) communication unit, and an infrared communication unit.

11. The projection display device according to claim 1, wherein the communication unit comprises a Universal Serial Bus (USB) port, and an IEEE 1394.

12. The projection display device according to claim 1, wherein the one or more inputs comprise at least one of: one or more image files, one or more video files, and one or more document files.

13. The projection display device according to claim 1, wherein the projection display device is capable of providing an audio support to the inputs, the audios support is coupled to a speaker.

14. A handheld projection display device for providing a high resolution projected image, the handheld projection display device comprising:
a communication unit for communicating with a host device, wherein the communication unit is capable of receiving one or more encoded inputs from the host device, the communication unit is further capable of enabling the host device to control the projection display device;
a system processor capable of decoding the one or more encoded inputs for generating a high resolution display;
a display unit operatively coupled to the system processor for projecting the high resolution image;
an in-built power source operatively coupled to the communication unit, the system processor and the display unit;
a storage unit for storing the one or more encoded inputs; and
a User Interface (UI) for enabling a user to operate the handheld projection display device.

15. The handheld projection display device according to claim 14, wherein the system processor is further capable of formatting the one or more inputs based on the properties of the one or more inputs.

16. The handheld projection display device according to claim 14, wherein the in-built power source is a rechargeable battery.

17. The handheld projection display device according to claim 14, wherein the storage unit comprises at least one of a removable storage unit and a local storage unit.

18. The handheld projection display device according to claim 14, wherein the UI enables the user to operate the host device.

19. The handheld projection display device according to claim 14, wherein the handheld projection display device is selected from the group consisting of a laser scanning based projection device, a transmissive micro imager based projection device, an emissive micro imager based projection device, a reflective micro imager based projection device, a holographic technology based projection device, a Cathode Ray Tube (CRT) based projection device, a Field Emission Display (FED), and a Digital Light Processing (DLP) based projection device.

20. The handheld projection display device according to claim 14, wherein the communication unit is a wireless communication unit.

21. The handheld projection display device according to claim 20, wherein the wireless communication unit comprises at least one of a Bluetooth unit, a wireless local area network communication units a radio frequency communication unit, a digital video broadcast (DVB-H) communication unit, an ultra wideband (UWB) communication unit, and an infrared communication unit.

22. The handheld projection display device according to claim 14, wherein the communication unit is a Universal Serial Bus (USB) port, and an IEEE 1394.

23. The handheld projection display device according to claim 14, wherein the one or more encoded inputs comprise at least one of: one or more image files, one or more video files, and one or more document files.

24. The projection display device according to claim 14, wherein the projection display device is capable of providing an audio support to the inputs, wherein the audio support is coupled to a speaker.

25. A handheld projection display device for providing a high resolution projected image, the handheld projection display device comprising:
a communication unit for communicating with a host device, wherein the communication unit is capable of receiving one or more encoded inputs from the host device the communication unit is further capable of enabling the host device to control the projection display device;
a system processor capable of decoding the one or more encoded inputs and formatting the one or more encoded inputs for generating a high resolution display;
a display unit operatively coupled to the system processor for projecting the high resolution image;
a storage unit for storing the one or more encoded inputs;
a User Interface (UI) enabling a user to operate at least one of the host device and the handheld projection display device; and
an in-built power source operatively coupled to the communication unit, the system processor, the display unit, the storage unit and the UI.

26. The handheld projection display device according to claim 25, wherein the in-built power source is a rechargeable battery.

27. The handheld projection display device according to claim 25, wherein the storage unit comprises at least one of a removable storage unit and a local storage unit.

28. The handheld projection display device according to claim 25, wherein the handheld projection display device is selected from the group consisting of a laser scanning based projection device, a transmissive micro imager based projection device, an emissive micro imager based projection device, a reflective micro imager based projection device, a holographic technology based projection device, a Cathode Ray Tube (CRT) based projection device, a Field Emission Display (FED), and a Digital Light Processing (DLP) based projection device.

29. The handheld projection display device according to claim 25, wherein the communication unit is a wireless communication unit.

30. The handheld projection display device according to claim 29, wherein the wireless communication unit comprises at least one of a Bluetooth unit, a wireless local area network communication unit, a radio frequency communication unit, a digital video broadcast (DVB-H) communication unit, an ultra wideband (UWB) communication unit, and an infrared communication unit.

31. The handheld projection display device according to claim 25, wherein the communication unit is a Universal Serial Bus (USB) port, and an IEEE 1394.

32. The handheld projection display device according to claim 25, wherein the one or more encoded inputs comprise at least one of: one or more image files, one or more video files, and one or more document files.

33. The projection display device according to claim 25, wherein the projection display device is capable of providing an audio support to the inputs, wherein the audio support is coupled to a speaker.
